(19) United States
(12) Patent Application Publication
(10) Pub. No.: US 2003/0213130 A1
(43) Pub. Date: Nov. 20, 2003

(54) Razor cartridge mounting structure

(76) Inventor: Vincent C. Motta, Norwalk, CT (US)

Correspondence Address: Daniel G. Mackas, McCormick, Paulding & Huber LLP, CityPlace II, 185 Asylum Street, Hartford, CT, 06103, US

(21) Appl. No.: 10/402,088

(22) Filed: Mar. 28, 2003

Related U.S. Application Data
(60) Provisional application No. 60/381,218, filed on May 16, 2002.

(51) Int. Cl. B26B 21/00

(52) U.S. Cl. 30/50; 30/526

(57) ABSTRACT

A razor in which an intermediate linkage (12) is interposed between handle (16) or frame (14) and a razor cartridge (10). The cartridge (10) is mounted to a pivot about a first axis (42) relative to the intermediate linkage (12); and the intermediate linkage (12) is mounted to pivot about a second axis (44) relative to the handle (16) or frame (14). The intermediate linkage (12) is resiliently biased toward and extreme counterclockwise position relative to the handle or frame; and the cartridge is resiliently biased to a neutral position relative to the intermediate linkage. The two axes (42, 44) are each parallel to the cutting edges of blades (20, 22, 24) carried by the cartridge (10).

### CROSS REFERENCE TO RELATED APPLICATIONS

This application is entitled to the benefit of and incorporates by reference essential subject matter disclosed in Provisional Patent Application No. 60/381,218 filed on May 16, 2002.

### BACKGROUND OF THE INVENTION

1. Field of the Invention

This invention relates to razors having one or more blades mounted in a cartridge together with a guard bar which is located in advance of the blade cutting edge to pull on skin being shaved by the blade.

2. Description of the Related Art

Razors having blade mounting cartridges which pivot with respect to a razor handle are well known. Examples of such razors are seen in U.S. Pat. No. 5,533,263, U.S. Pat. No. 5,535,518, U.S. Pat. No. 5,787,593, U.S. Pat. No. 5,953,824, U.S. Pat. No. 5,661,907 and U.S. Pat. No. 6,122,826 and U.K. patent application GB 2 162 111A. The purpose of pivoting the blade cartridge is to enable the blades of the razor to follow the contours of the skin being shaved. In general, the cartridge is lightly resiliently biased to a neutral position from which it pivots in response to different pressures which are produced as the cartridge encounters different skin contours.

It is also known to pivot a shaving cartridge about an axis which passes through a guard element in the cartridge and to spring bias the cartridge in a direction to press against the surface of the skin being shaved. The purpose of this arrangement is to maintain steady pressure of the cartridge against the skin surface irrespective of movements of the razor handle toward and away from the skin. An example of a cartridge pivoting arrangement having a pivot axis which passes through the guard element is shown in U.S. Pat. No. 5,813,293 and U.S. Pat. No. 5,918,369.

Although use of a pivot which passes through the guard element is useful in maintaining a steady pressure of the cartridge against the skin as the handle is moved up and down, difficulties are encountered when the cartridge itself attempts to follow the various contours of the skin. In order for a pivoted cartridge to follow the contours of the skin being shaved, the cartridge should be pivoted in a region which is balanced with respect to the blade edge or edges. That is, where there is a single blade, the pivot axis should be in the general region of the blade edge. Where the cartridge has two blades, the pivot axis should be somewhere between the two blade edges; and where there are three blades the pivot axis should be in the region of the edge of the middle blade. However, with this pivoting arrangement, the pressure of the blades against the skin is subject to movements of the razor handle toward and away from the skin surface; and it is therefore not possible to regulate the pressure of the blades against the skin. Thus, there is danger of the razor being pressed too hard against the skin which could cause irritation or even cuts in the skin.

In the case where the cartridge pivot axis passes through the guard element, the pressure of the guard element against the skin during shaving produces a reverse torque on the cartridge which causes it to pivot away from the skin surface. As a result, a close shave is not provided.

### SUMMARY OF THE INVENTION

The present invention makes it possible to provide a dose shave with regulated and uniform pressure of the cutting blade edges against the skin surface, and at the same time to allow the blades to follow the contours of the skin being shaved. According to the present invention, there is provided a novel razor construction which comprises a frame, an intermediate linkage and a blade cartridge. The blade cartridge has a guard bar and a plurality of blades with edges which are parallel to and located one after the other behind the guard bar. The frame may be a razor handle or it may be part of a razor handle. The intermediate linkage is mounted on the frame to pivot about a first pivot axis which is parallel to the blade cutting edges; and cartridge is mounted on the intermediate linkage to pivot about a second pivot axis which is parallel to the first pivot axis. The first pivot axis is preferably located ahead of the blade edges and most preferably in the region of the guard bar; and the second pivot axis is located in a region central to the blade cutting edges. The cartridge is resiliently biased to a neutral pivot position relative to the intermediate linkage; and the intermediate linkage is resiliently biased to a rest pivot position which brings the blades toward a surface to be shaved. This double pivot arrangement allows the blade or blades to follow the contours of the skin being shaved while the guard bar remains free of the effects of pressure from the handle or frame. Thus, a uniform pressure of the blade edges against the skin surface is maintained irrespective of movements of the handle toward or away from the skin surface.

### BRIEF DESCRIPTION OF THE DRAWINGS

FIG. 1 is a diagrammatic side section view showing an example of a razor according to the present invention and showing an intermediate linkage at a rest position relative to a frame, and a razor cartridge at a neutral position relative to the intermediate linkage;

FIGS. 2a, 2b and 2c are diagrammatic side section views showing respectively, the neutral and positive and negative positional relationships between the razor cartridge and the intermediate linkage of the razor of FIG. 1;

FIG. 3 is a view similar to FIG. 1 but showing the intermediate linkage pivoted from its rest position relative to the frame, and the razor cartridge in its neutral position relative to the intermediate linkage;

FIG. 4 is a view similar to FIG. 1 but showing the intermediate linkage pivoted from its rest position relative to the frame, and the razor cartridge pivoted to a positive position relative to the intermediate linage; and

FIG. 5 is a view similar to FIG. 1 but showing the linkage and razor cartridge mechanically locked in their at rest and neutral positions, respectively;

### DETAILED DESCRIPTION OF THE PREFERRED EMBODIMENT

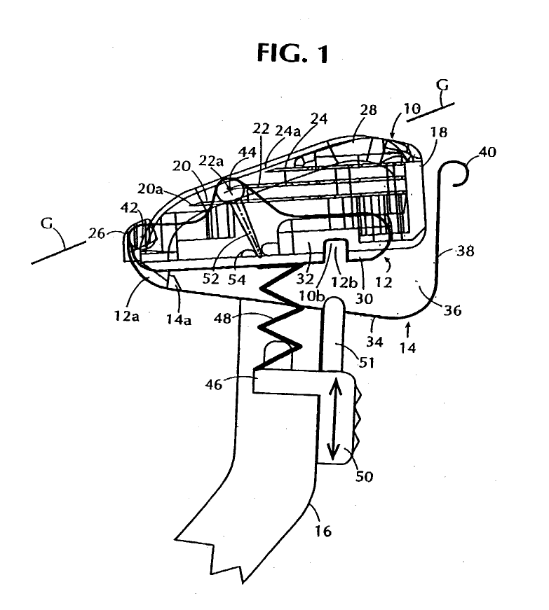

The razor shown in FIG. 1 comprises a blade cartridge 10, an intermediate linkage 12, a frame 14 and a handle 16. Only the upper portion of the handle 16 is shown in FIG. 1. The frame 14 is fixed to and forms part of the handle 16.

The cartridge 10 comprises a housing 18 which supports three blades 20, 22 and 24 which have cutting edges 20a, 22a and 24a. The blade cutting edges are parallel to and face in the general direction of a guard bar 26 which is also mounted in the housing 18. It is not necessary that there be three blades. The invention is applicable to razors which have any number of multiple blades including, for example, two blades or four blades. A cap 28 is also mounted in the housing 18 behind the blade edges 20a, 22a and 24a, i.e. in a direction opposite to that of the guard bar 26.

The intermediate linkage 12 comprises a flat lower strip 30 which extends below the cartridge 10, and bent up end portions 32 which extend up along and adjacent to the ends of the cartridge 10.

The frame 14 comprises a flat strip 34 which extends under the lower strip 30 of the intermediate linkage 12, and bent up end portions 36 which extend up along and adjacent to the bent up end portions 32 of the intermediate linkage 12. The frame 14 also has a bent up rear portion 38 which extends up along the length of and rearwardly of the cartridge 10. The upper end of the rear portion 38 is bent in the form of a curl which forms a limiting guard 40. The intermediate linkage 12 is pivotally mounted on the frame 14 to pivot about a first pivot axis 42 which is located ahead of the blade edges 20a, 22a and 24a. Preferably, the first pivot axis 42 is in the vicinity of the guard bar 26. The pivotal mounting of the intermediate linkage 12 to the frame 14 may be provided by pivots which connect the bent up portions 32 and 36 the intermediate linkage and of the frame. Other structural arrangements may be used to pivot the intermediate linkage 12 to the frame 14 so long as they permit the intermediate linkage to pivot about an axis which is parallel to, and forwardly of, the blade edges.

The cartridge 10 is mounted on the intermediate linkage 12 to pivot about a second pivot axis 44 which extends parallel to the blade edges 20a, 22a and 24a. This pivot axis passes through the bent up end portions 32 of the linkage 12 in a central region of the blade edges, for example dose to the middle blade edge 22a. While the cartridge 10 is shown to be pinned to the bent up portions 32 of the intermediate linkage 12, any other structural arrangement which allows the cartridge 10 to pivot about an axis which is parallel to and in a central region of the blade edges may be provided. For example, the cartridge 10 may be provided with trunnions which mate with journals formed on the intermediate linkage 12 to form a virtual axis parallel to and in a central region of the blade edges.

A spring support 46 is mounted on handle 16 and a compression spring 48 extends between the support 46 and the intermediate linkage 12. The spring 48 biases the intermediate linkage 12 in a counterclockwise direction as shown in FIG. 1 so that in the absence of opposing forces on the intermediate linkage 12, a stop element 12a thereon is forced against an abutment 14a on the frame 14. This is the rest position of the intermediate linkage 12. That is, the spring 48 biases the intermediate linkage to pivot about the first pivot axis 42 until the stop element 12a comes into contact with the abutment 14a. The intermediate linkage carries the cartridge 10 so that the blade edges 20a, 22a and 24a of the cartridge 10 lie in the plane indicated by the line G when the intermediate linkage 12 is at its rest position relative to the frame 14 and the cartridge 10 is in its neutral position relative to the intermediate linkage 12. Other spring biasing arrangements will be readily apparent to those skilled in the art; and this invention is intended to cover all such arrangements. The only qualification for purposes of this invention is that some resilient means be provided to bias the intermediate linkage 12 so that it exerts a pivot force in a counterclockwise direction, as viewed in FIG. 1, and tends to bring the blade cutting edges 20a, 22a and 24a into the shaving plane G.

A slide button 50 is provided on the handle 16 and is moveable up and down thereon to selected positions identified by position notations “LIGHT”, “HEAVY” and “LOCK” in FIG. 1. When the slide button 50 is in its lowermost or “LIGHT” position, it holds the spring support 46 at a location where it least compresses the spring 48. With the spring thus lightly compressed, the intermediate linkage 12 can pivot about the first pivot axis 42 in a clockwise direction from its rest position in response to the least amount of force against the intermediate linkage 12. In this condition the intermediate linkage 12 permits shaving on sensitive skin surfaces without imposing undue pressure on the skin.

When the slide button 50 is moved up to its “HEAVY” position, it brings the spring support 48 to a location where it applies greater compression to the spring 48. As a result, a greater amount of force against the intermediate linkage is needed to move the linkage from its rest position. This enables the razor to press against a heavy beard for a dose shave.

When the slide button 50 is moved further up to its “LOCK” position, a locking projection 51 on the button 50 is forced into a locking recess 12b in the intermediate linkage 12, as well as into an aligned locking recess 10b in the cartridge 10. This mechanically locks the intermediate linkage in its rest position relative to the frame 14; and it also mechanically locks the cartridge 10 in its neutral position relative to the linkage 12. In this condition the position of the shaving plane defined by the blade edges 20a, 22a and 24a is controlled solely by the position of the handle 16 so that the person using the razor has complete and independent control of the shaving plane. This feature may be used when it is desired to shave dose to sharp skin contours where a pivotal blade support does not provide satisfactory shaving.

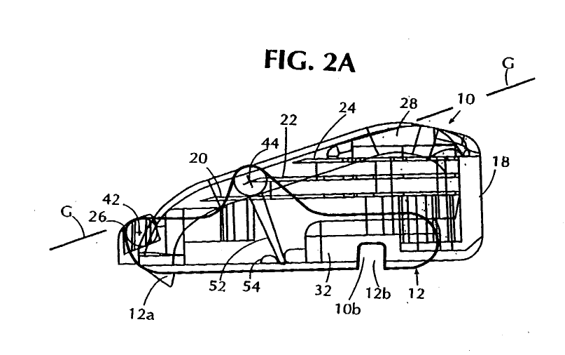

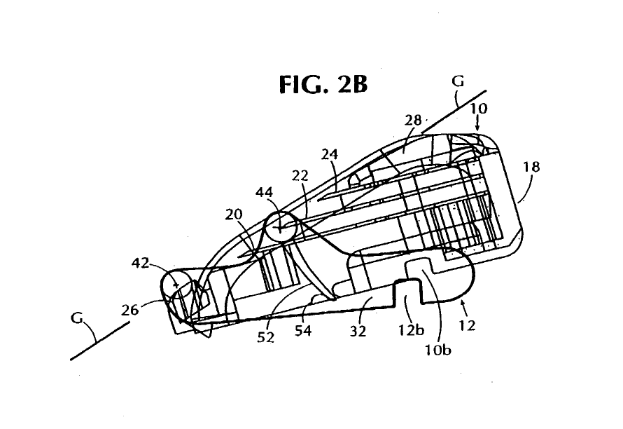

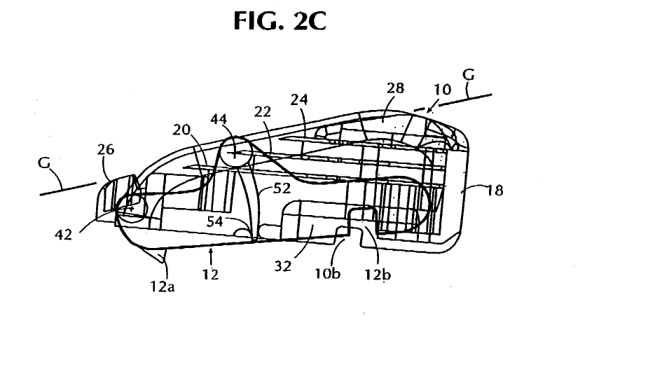

A second spring 52, which may be a leaf spring, extends from the intermediate linkage 12 in the region of the second pivot axis 44, to a recess 54 formed in the lower region of the cartridge 10. This second spring 52 biases the cartridge to a neutral position relative to the intermediate linkage 12. The second spring 52 allows the cartridge 10 to pivot both clockwise and counterclockwise about the second pivot axis 44 from its neutral position as the shaving plane defined by the blade edges 20a, 22a and 24a follows the contour of the surface being shaved. This is illustrated in FIG. 2a, which shows the cartridge 10 in its neutral position relative to the intermediate linkage 12; in FIG. 2b, which shows the cartridge 10 moved against the force of the spring 52 to a counterclockwise position relative to the intermediate linkage 12; and in FIG. 2c, which shows the cartridge 10 moved in the opposite direction to a clockwise position relative to the intermediate linkage 12.

Other spring biasing arrangements may be used in place of the leaf spring 52; for example, a torsion bar may be used as the second axis 42. What is important is that the cartridge 10 be resiliently biased to a neutral rotational position relative to the linkage 12 and that it be pivotal in both clockwise and counterclockwise directions from this position in accordance with forces imposed on the blade edges 20a, 22a and 24a during shaving.

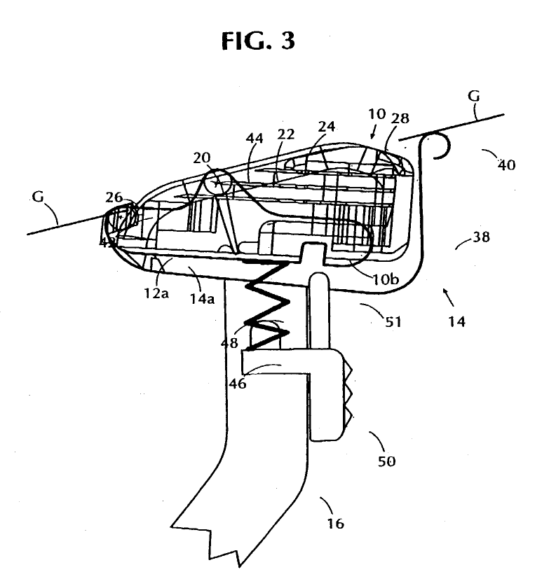

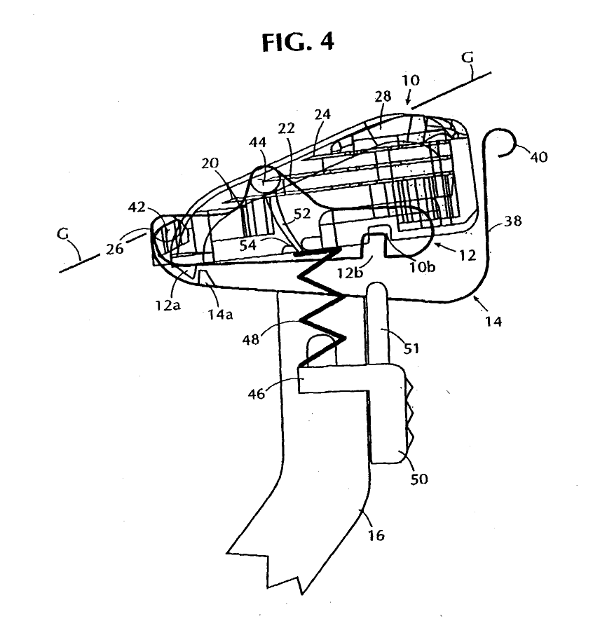

FIG. 3 shows the entire razor assembly in its unlocked condition with the cartridge 10 in its neutral position relative to the intermediate linkage 12 but with the intermediate linkage 12 pivoted with respect to the frame 14 about the first pivot axis 42 from its rest position. As can be seen, the stop element 12a has moved back from the abutment 14a of the frame 14. This pivoting movement by itself corresponds to the pivoting movement of known razors which have one pivoted element and one pivot axis. However the razor assembly of FIG. 3 is novel in that it has an additional pivoted element which pivots about a second pivot axis to achieve a more flexible positioning of the shaving plane defined by the blade edges so that the shaving plane remains contiguous with the surface being shaved. This is illustrated in FIG. 4.

As shown in FIG.4, the intermediate linkage 12 is pivoted from its rest position clockwise relative to the frame 14, as in FIG.3. However, as shown in FIG.4, the cartridge 10 is itself pivoted from its neutral position counterclockwise relative to the intermediate linkage 12. Thus, as the razor is pressed against the surface being shaved, the tendency of the following blade edge i.e. blade edge 24a, to be pulled back from the surface, is overcome by the counterclockwise movement of the cartridge 10 about the second pivot axis 44 which brings this following blade edge back to the surface being shaved. Moreover, should the cartridge 10 encounter forces which tend to move it either clockwise or counterclockwise, such forces will be counterbalanced by the section of the spring 52 on the cartridge.

It will be appreciated that the first pivot axis 42, between the frame 14 and the intermediate link 12, is located forwardly of the blade edges and preferably in the region of the guard 26. This allows the razor handle 16 to drag the blades 20, 22 and 24 across the surface being shaved while the resilient bias of the first spring 48 tends to pivot the cartridge about the first axis to maintain it against the surface being shaved. However, when the guard portion of the razor is pushed against the surface being shaved the drag which the shaving surface produces on the razor tends to cause it to pivot in the reverse direction so that the third blade 24 is pulled away from the surface. However, the second pivot axis 44 is located near the center of the cutting plane of the cartridge 10, i.e. near the cutting edge 22a of the second blade 22. This serves to maintain a balance of the forces on the blades so that each of them always remains in shaving contact with the surface being shaved.

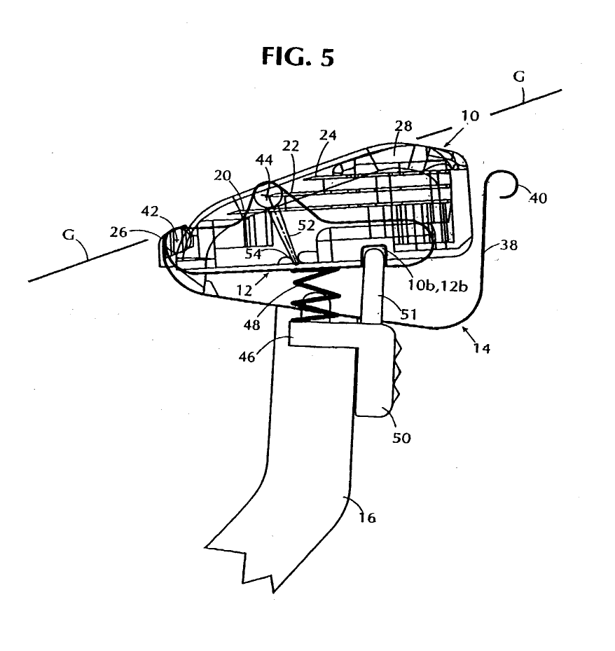

As can be seen in FIG. 4, the cartridge 10 is formed at the underside thereof with a locking recess 10a which, when the cartridge is in its neutral position relative to the intermediate link 12, becomes aligned with the locking recess 12a in the intermediate link 12. Thus, when the cartridge 10 is in its neutral position relative to the intermediate link 12, and the intermediate link is in its rest position relative to the frame 14, the respective locking recesses 10a and 12a become aligned with each other and with the locking projection 51 on the slide button 50. Thus when the slide button 50 is pushed to its uppermost position, the locking projection enters into both locking recesses 10a and 12a as shown in FIG. 5, thus maintaining the cartridge 10 and the intermediate link fixed relative to the frame 14 and the handle 16. This allows the position of the blade edges 20a, 22a and 24a to be under the sole control of the handle 16.

It should be understood that different arrangements may be provided for locking the cartridge 10 and the intermediate link 12 in fixed position with respect to the frame 14 and handle 16; and the present invention is not limited to the specific locking mechanism described above.

1. A razor construction comprising:
a blade cartridge having a guard bar and a plurality of blades mounted thereon, said blades having cutting edges parallel to and facing generally toward said guard bar;
an intermediate linkage; and
a frame;
said cartridge being pivotally mounted on said intermediate linkage to pivot about a first pivot axis which is parallel to said blade cutting edge,
said intermediate linkage being pivotally mounted on said frame to pivot about a second pivot axis which is parallel to said first pivot axis,
said intermediate linkage and said cartridge being resiliently biased toward predetermined rest positions.

2. A razor construction according to claim 1, wherein
said cartridge is moveable over a first pivot range with respect to said intermediate linkage.

3. A razor construction according to claim 2, wherein said intermediate linkage is moveable over a second pivot range with respect to said frame.

4. A razor construction according to claim 1, wherein said first pivot axis is located in the region of said guard and said second pivot axis is located in the region of said blade cutting edge.

5. A razor construction according to claim 2, wherein said cartridge is resiliently biased to a neutral position substantially at the midpoint of said first pivot range and wherein said cartridge is movable in clockwise and counterclockwise directions from said neutral position.

6. A razor construction according to claim 3, wherein said intermediate linkage is resiliently biased to a pivot position substantially at one end of said second pivot range, said one end of said range being a position in which said intermediate linkage is closest to a surface to be shaved.

7. A razor construction according to claim 6, wherein said intermediate linkage includes a stop element and wherein said frame includes an abutment, said stop element and said abutment being in contact with each other at said rest position of said intermediate linkage and being displaced from each other when said intermediate linkage is away from said rest position.

8. A razor construction according to claim 1, wherein said cartridge has first, second and third blade edges arranged one after the other and wherein said second axis is in the vicinity of said second blade edge.

9. A razor construction according to claim 1, wherein said intermediate linkage is adjustably biased toward a predetermined position.

10. A razor construction according to claim 1, further including a lock mechanism which can be set to hold said intermediate linkage at its rest position.

11. A razor construction according to claim 10, wherein said locking mechanism is constructed to hold said cartridge at a neutral position with respect to said intermediate link.

12. A razor construction according to claim 11, wherein said locking mechanism comprises a locking protrusion which is movable into locking recesses in said intermediate linkage and said cartridge to hold said intermediate link in its rest position and to hold said cartridge in its neutral position.

13. A razor construction comprising:
a blade cartridge having a guard bar and at least one blade mounted therein, said blade having a cutting edge parallel to and facing generally toward said guard bar;
an intermediate linkage;
said cartridge being pivotally mounted on said intermediate linkage to pivot with respect to said intermediate linkage over a first pivot range about a first pivot axis which is parallel to said blade cutting edge;
a frame;
said intermediate linkage being pivotally mounted on said frame to pivot with respect to said frame over a second pivot range about a second pivot axis which is parallel to said first pivot axis;
said first pivot axis being located in the region of said guard and said second pivot axis being located in the region of said blade cutting edge;
said cartridge being resiliently biased to a neutral pivot position substantially at the midpoint of said first pivot range; and
said intermediate linkage being resiliently biased to a pivot position substantially at one end of said second pivot range such that the bias on said intermediate linkage brings said blades toward a surface to be shaved.

14. A razor construction according to claim 13, wherein said cartridge has first, second and third blade edges arranged one after the other and wherein said second pivot axis is in the vicinity of said second blade edge.

15. A razor construction according to claim 14, wherein said first pivot axis is in the vicinity of said guard.
